(19) United States
(12) Patent Application Publication
(10) Pub. No.: US 2005/0140992 A1
(43) Pub. Date: Jun. 30, 2005

(54) Image output apparatus and image output method therefor, and program for implementing the method

(75) Inventor: Akihito Mochizuki, Narashino-shi (JP)

Correspondence Address: ROSSI & ASSOCIATES, P.O. BOX 826, ASHBURN, VA, 20146-0826, US

(73) Assignee: CANON KABUSHIKI KAISHA

(21) Appl. No.: 11/017,167

(22) Filed: Dec. 20, 2004

(30) Foreign Application Priority Data
Dec. 26, 2003 (JP) 2003-435642(PAT)

(51) Int. Cl. G06F 15/00

(52) U.S. Cl. 358/1.8; 358/471

(57) ABSTRACT

An image output apparatus which is inexpensive, flexible and free from increases in cost and size of the apparatus due to an increase in buffer memory capacity brought about by higher image quality and from complication of the line separation process brought about by a change in printing paper size or resolution. An image memory stores a plurality of image data corresponding, respectively, to the plurality of light beams. A plurality of image data controllers convert respective ones of the plurality of image data output from the image memory into the plurality of image signals for controlling the plurality of light beams, respectively and output the image signals to the printer engine interface. A DMA controller transfers the plurality of image data stored in the image memory to the image data controllers according to processing results of the image data controllers.

### BACKGROUND OF THE INVENTION

1. Field of the Invention

The present invention relates to an image output apparatus such as a printer controller that supplies image data to a color printer engine, an image output method therefor, and a control program for implementing the method.

2. Description of the Related Art

In recent years, as office documents have become colorized, it is desirable that printers also output color images. A printer capable of outputting color images requires processing of image data of four colors, cyan (C), magenta (M), yellow (Y) and black (K), and consequently a processing load on a printer controller that supplies image data to a color printer engine has tended to increase.

With a color printer of this type, to print color images at high speed, a tandem method is used in which a plurality of photosensitive drums are provided for the respective colors and the process of printing images of the respective colors are carried out in parallel. Moreover, to further improve printing speed, a printing method called the multibeam method is known that forms images using a plurality of light beams. The multibeam method, which scans the photosensitive drum with a plurality of laser beams from a plurality of laser light sources simultaneously and in parallel, makes it possible to improve printing speed while reducing the scanner rotational speed and the frequency of the image signal.

For a printer engine using the multibeam method described above, the printer controller (image output apparatus) that outputs image signals for controlling laser beams of the respective colors is provided with as many line memories capable of holding one line of image data as the laser beams, and controlled so as to output such image data in synchronism with the scan timing (see, for example, Japanese Published Patent No. H08-034537 (Japanese Laid-Open Patent Publication (Kokai) No. S63-020955) and Japanese Laid-Open Patent Publication (Kokai) No. H11-72726).

For example, an image output apparatus disclosed in Japanese Published Patent No. H08-034537 (Japanese Laid-Open Patent Publication (Kokai) No. S63-020955) has two buffer memories (line memories). When scanning the photosensitive drum with the laser beams, these two buffer memories are used repeatedly alternately at each line to read and to write (i.e., a method of performing toggle control of two memories for scan of two lines). Moreover, in Japanese Laid-Open Patent Publication (Kokai) No. H11-72726, to provide image signals respectively for a plurality of light beams to an apparatus that simultaneously generates the plurality of light beams, a method is adopted in which as many FIFO memories (first-in, first-out storage devices) as the light beams are used.

Moreover, a multibeam scanning apparatus that scans with two beams is known in which image data for two lines (an odd-numbered line and an even-numbered line) are alternately banded from a renderer to a writing memory (SGRAM) (Synchronous Graphics Random Access Memory) through a DMA (direct memory access) block, the two lines are transferred to a video shipper in the order of odd to even after banding is completed, and, after being stored in a line buffer of the video shipper, an odd-numbered line data video signal and an even-numbered line data video signal are simultaneously output to an engine I/F (for example, Japanese Laid-Open Patent Publication (Kokai) No. 2003-341129).

However, the image output apparatuses applied to the printer engine of the multibeam method according to the prior art described above have the following problems:

(1) As the number of laser beams simultaneously scanned increases and the amount of data output in each line increases due to higher resolutions, the required buffer memory capacity and required buffer memory number also increase, which leads to increased cost and size of the apparatus.

(2) With the above configuration described in Japanese Published Patent No. H08-034537 (Japanese Laid-Open Patent Publication (Kokai) No. S63-020955), when writing data to the buffer memories, it is necessary to execute in real time a line separation process that separates the image data line by line. However, one line of image data varies in effective recording pixel number depending on the size of the printing paper, and hence the line separation process becomes complicated. Moreover, where the data is compressed to reduce the data amount, the compressed data is not of uniform size, which makes the line separation process even more complicated.

### SUMMARY OF THE INVENTION

It is an object of the present invention to provide an image output apparatus which is inexpensive, flexible and free from increases in cost and size of the apparatus due to an increase in buffer memory capacity brought about by higher image quality and from complication of the line separation process brought about by a change in printing paper size or resolution, and an image output method therefor and a program for implementing the method.

To attain the above object, in a first aspect of the present invention, there is provided an image output apparatus that supplies a plurality of image signals for controlling a plurality of light beams, respectively, to a printer apparatus that forms an image by scanning the plurality of light beams simultaneously and in parallel, comprising a plurality of storage devices that store a plurality of image data corresponding, respectively, to the plurality of light beams, and a plurality of data processing devices that convert respective ones of the plurality of image data output from the plurality of storage devices into the plurality of image signals for controlling the plurality of light beams, respectively and output the image signals to the printer apparatus, and a transfer device that transfers the plurality of image data stored in the plurality of storage devices to the data processing devices according to processing results of the data processing devices.

With the arrangement of the first aspect of the present invention, a line memory capable of holding one line of image data can be dispensed with. Therefore, it is possible to realize an image output apparatus which is inexpensive, flexible and free from increases in cost and size of the apparatus due to an increase in buffer memory capacity brought about by higher image quality and from complication of the line separation process brought about by a change in printing paper size or resolution.

Preferably, the image output apparatus comprises a separation device that separates image data formatted in units for scanning into a plurality of image data corresponding, respectively, to the plurality of light beams, and each of the plurality of storage devices stores corresponding data of the plurality of image data separated by the separation device in scanning order.

More preferably, the image output apparatus further comprises a data compression device that compresses image data, and the data compression device compresses the plurality of image data stored in the storage devices before being formatted in units for scanning, and wherein each of the data processing devices expands corresponding data of the compressed image data and the transfer device supplies the expanded image data to a corresponding one of the data processing devices as the expansion is carried out.

Preferably, the image signals output from the data processing devices are output in synchronism with a signal supplied from the printer apparatus.

Preferably, the transfer device comprises a DMA controller comprising independently operable DMA channels corresponding in number to the number of the light beams.

To attain the above object, in a second aspect of the present invention, there is provided an image output method for an image output apparatus that supplies a plurality of image signals for controlling a plurality of light beams, respectively, to a printer apparatus that forms an image by scanning the plurality of light beams simultaneously and in parallel, comprising a storage step of storing a plurality of image data corresponding, respectively, to the plurality of light beams in a plurality of discrete storage areas, respectively, a transfer step of transferring the plurality of image data stored in the plurality of discrete storage areas separately and independently to a plurality of data processing devices, and a data processing step of converting the plurality of image data transferred in the transfer step into the plurality of image signals for controlling the plurality of light beams, respectively and outputting the image signals to the printer apparatus.

Preferably, the storage step comprises separating image data formatted in units for scanning into a plurality of image data corresponding, respectively, to the plurality of light beams and storing the separated plurality of image data in the storage areas in scanning order.

More preferably, an image output method further comprises a data compression step of compressing the plurality of image data stored in the storage areas before being formatted in units for scanning, and the data processing step comprises expanding the compressed image data and the transfer step comprises supplying the expanded image data to the data processing devices as the expansion is carried out.

Preferably, the image signals output in the data processing step are output in synchronism with a signal supplied from the printer apparatus.

To attain the above object, in a third aspect of the present invention, there is provided a computer-readable program for executing an image output method for an image output apparatus that supplies a plurality of image signals for controlling a plurality of light beams, respectively, to a printer apparatus that forms an image by scanning the plurality of light beams simultaneously and in parallel, comprising a storage module for storing a plurality of image data corresponding, respectively, to the plurality of light beams in a plurality of discrete storage areas, respectively, a transfer module for transferring the plurality of image data stored in the plurality of discrete storage areas separately and independently to a plurality of data processing devices, and a data processing module for converting the plurality of image data transferred by the transfer module into the plurality of image signals for controlling the plurality of light beams, respectively and outputting the image signals to the printer apparatus.

Preferably, the storage module separates image data formatted in units for scanning into a plurality of image data corresponding, respectively, to the plurality of light beams and stores the separated plurality of image data in the storage areas in scanning order.

More preferably, the plurality of image data stored in the storage areas are compressed before being formatted in units for scanning, and the data processing module expands the compressed image data and the transfer module supplies the expanded image data to the data processing devices as the expansion is carried out.

Preferably, the image signals output by the data processing module are output in synchronism with a signal supplied from the printer apparatus.

The above and other objects, features, and advantages of the invention will become more apparent from the following detailed description taken in conjunction with the accompanying drawings.

### BRIEF DESCRIPTION OF THE DRAWINGS

FIG. 1 is a diagram showing the connection of a printer incorporating an image output apparatus according to an embodiment of the present invention to a host computer;

FIG. 2 is a block diagram showing the configuration of a controller appearing in FIG. 1;

FIG. 3 is a diagram showing an example of image data stored in an image memory;

FIG. 4 is a block diagram showing the internal configuration of an image data controller appearing in FIG. 2;

FIG. 5 is a flow chart showing a process for storing image data in the image memory;

FIG. 6 is a timing diagram showing the relationship between a vertical synchronizing signal and laser outputs during execution of a printing process; and

FIG. 7 is a flow chart showing the printing process.

### DETAILED DESCRIPTION OF THE PREFERRED EMBODIMENTS

The present invention will now be described in detail with reference to the drawings showing a preferred embodiment thereof.

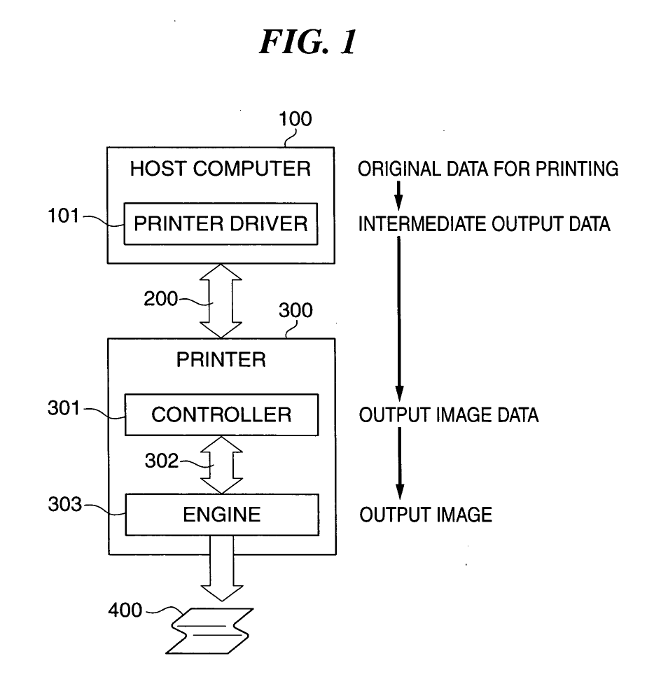

FIG. 1 is a diagram showing the connection of a printer incorporating an image output apparatus according to an embodiment of the present invention to a host computer. The image output apparatus according to the present embodiment is used as a printer controller.

The printer 300 is connected to a host computer 100, which includes a printer driver 101, through a connecting means 200 such as a network or a USB interface. The host computer 100 generates intermediate output data from original data for printing using the printer driver 101.

The printer 300 is comprised of a controller 301 that converts the intermediate output data output from the printer driver 101 into output image data suitable for printing, and an engine 303 that obtains output image data output from the controller 301 and outputs an image to a medium 400 such as paper. That is, the controller 301 outputs output image data to the engine 303 in synchronism with an image transfer enable signal from the engine 303. The printer engine 303 drivingly controls execution of an electrophotographic process to reproduce the output image date input from the controller 301 as an image on the medium 400.

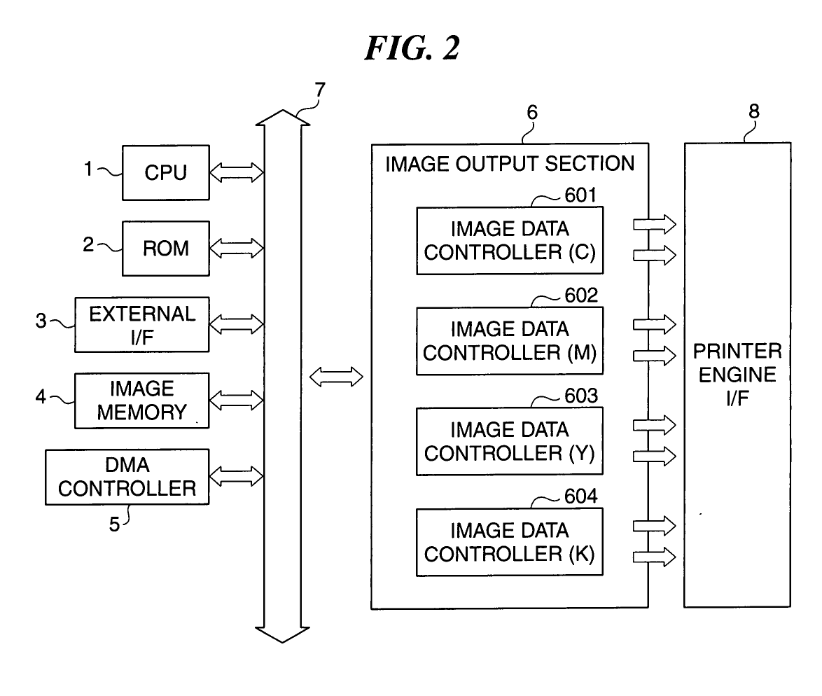

FIG. 2 is a block diagram showing the configuration of the controller 301 appearing in FIG. 1.

As shown in FIG. 2, the controller 301 is image memory 4, a DMA controller 5 and an image output section 6, each connected to a system bus 7. The image output section 6 converts the image data into signals suited to the laser outputs and outputs the signals to a printer engine interface (I/F) 8. Here, a description will be given taking as an example a multilaser printer that outputs two laser beams for each of the four colors.

The CPU 1 controls the entire controller 301 as well as generates compressed image data from the above-mentioned intermediate output data received via the external I/F 3, and then stores the compressed image data in a predetermined format in the image memory 4.

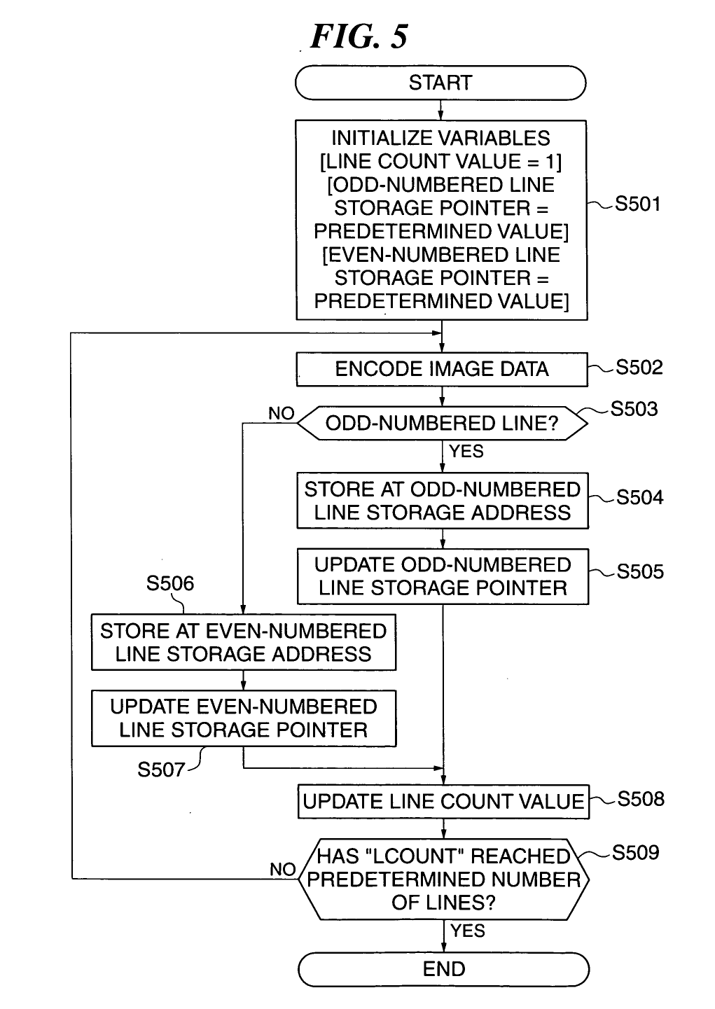

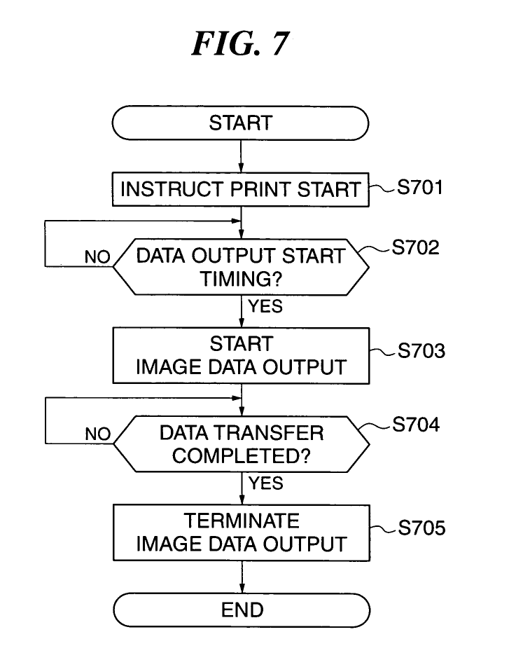

The ROM 2 stores processing routines to be executed by the CPU 1 (programs including control programs for executing processes shown by flow charts in FIG. 5 and FIG. 7), as well as font data and the like. The external I/F 3 may be implemented by a LAN interface such as Ethernet (registered trademark) or an i/o interface such as USB, IEEE 1284 or IEEE 1394, and receives print data from the host computer 100 as a host apparatus. The image memory 4 temporarily stores print data generated by the CPU 1 for one page or in units of blocks into which the print data for one page is divided. At this time, to save memory capacity, a process for compressing the print data is carried out by the CPU 1 to store the print data in a compressed by the CPU 1 to store the print data in a compressed data format.

The DMA controller 5 transfers the print data stored in the image memory 4 to the image output section 6. The image output section 6 has the capability to convert the image data transferred from the image memory 4 on color-by-color basis into signals suited to laser outputs and to output the signals to the printer engine I/F 8, and is comprised of image data controllers 601 to 604 that execute processing on image data of respective colors in parallel. The printer engine I/F 8 sets output timing of the image output section 6 so as to be synchronous with the operation of the engine 303, and also outputs image signals for controlling the respective laser beams from the image output section 6 to the engine 303.

Next, a description will be given of the storage format of the image data stored in the image memory 4 described above.

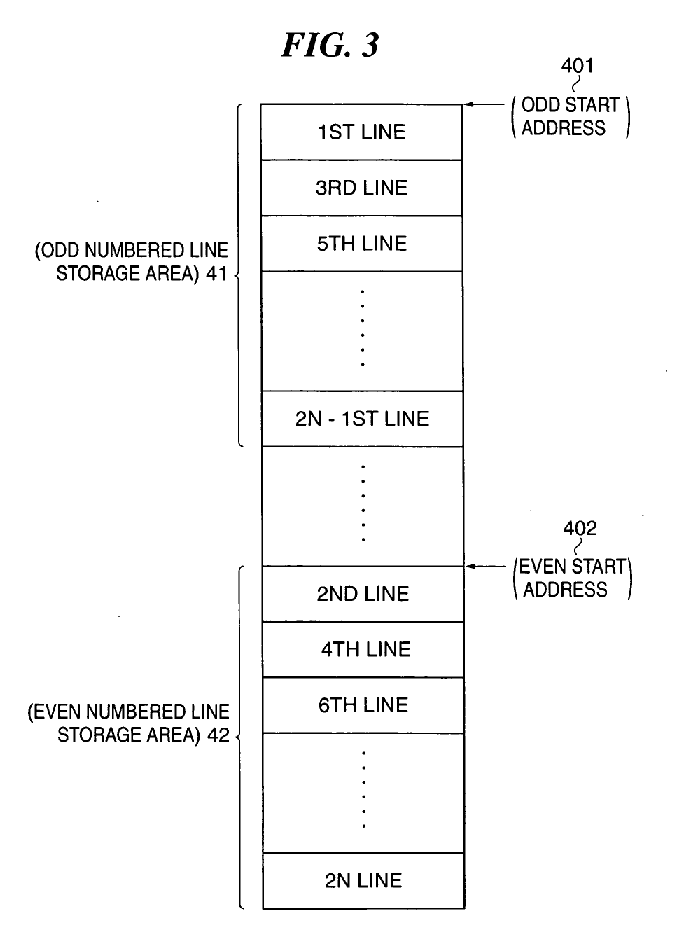

FIG. 3 is a diagram showing an example of the image data stored in the image memory 4.

The image data is formatted in a predetermined format, that is, in single-line portions as scanning units, and as shown in FIG. 3, the single-line portions of the data are stored in a manner divided into an odd-numbered line area 41 and an even-numbered line area 42 and in the order in which they are scanned. As for the method of formatting the image data into the predetermined format, compression processing using entropy encoding or the like is desirable in view of reduced memory capacity. However, the present invention is not limited to any particular image data compression method, and any method appropriate to the system performance can be adopted.

Moreover, the example in FIG. 3 shows storage of data of a single color, for example, and in the case of a color printer that mixes image data of the four colors cyan (C), magenta (M), yellow (Y) and black (K), the data is similarly separated into odd-numbered line data and even-numbered line data for each color and stored in the image memory 4. An ODD start address indicated by reference numeral 401 is the storage start address of the first line of data, after which the odd-numbered lines of data are stored. An EVEN start address indicated by reference numeral 402 is the storage start address of the second line of data, after which the even-numbered lines of data are stored.

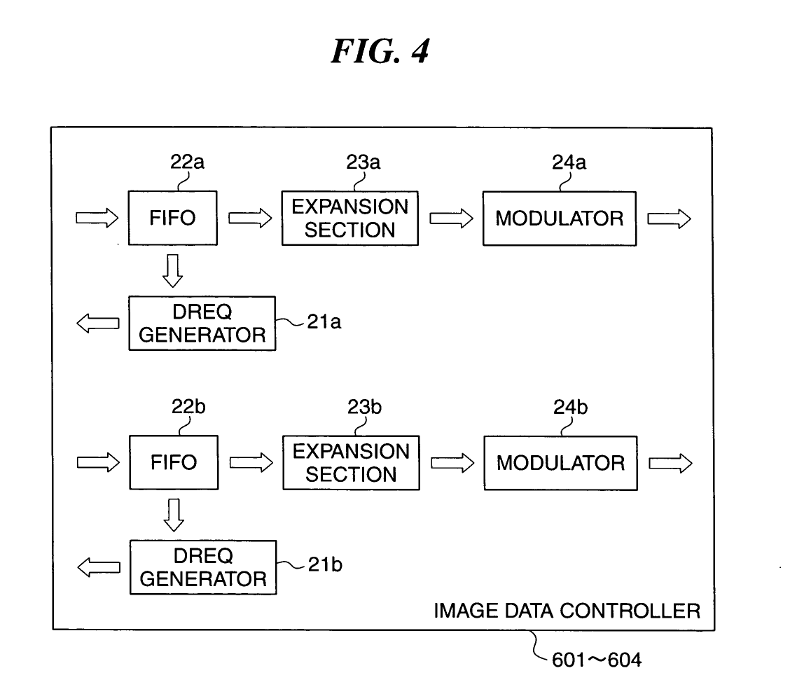

FIG. 4 is a block diagram showing the internal configuration of the image data controllers 601 to 604 appearing in FIG. 2.

The image data controllers 601 to 604 execute processing on the respective colors in parallel, and are identical in internal configuration with each other. Moreover, the image data controllers 601 to 604 include identical components indicated by reference numerals 21a-24a and 21b-24b, with the components 21a-24a executing data processing on the data for odd-numbered lines and the components 21b-24b executing data processing on the data for even-numbered lines. Of the two laser beams scanned in parallel, odd-numbered line output signals are provided to the laser beam that scans first in the direction of movement of the printing paper (the print direction) and even-numbered line output signals are provided to the other laser beam, respectively.

A DREQ generator 21a generates a data transfer request signal to the DMA controller 5. Reference numeral 22a designates a FIFO (first-in, first out) memory, which functions to adjust any difference in speed between the data transfer from the image memory 4 and the image data output to the engine 303. The DREQ generator 21a and the FIFO memory 22a operate in tandem. Specifically, the DREQ generator 21a monitors the difference between the number of pieces of data written to the FIFO 22a and the number of pieces of data read therefrom and issues a transfer data request to the DMA controller 5 as long as that difference does not exceed a predetermined value. Therefore, the minimum required capacity that enables an operating clock on which the system bus 7 operates and a laser output video clock to operate asynchronously suffices for the FIFO 22a, and the large capacity as used in the prior art enabling a single line of data to be stored is not required.

Moreover, an expansion section 23a executes a process of expanding the image data compressed and stored in the image memory 4. Thus, the FIFO memory 22a operates to supply or replenish data as the expansion process is carried out by the expansion section 23a. Further, a modulator 24a carries out conversion of the image data into signals suited to laser output. These signals that are adapted to laser output are expanded data subjected to pulse width modulation (PWM).

A description will now be given of the process for storing image data in the image memory 4 described above with reference to the flow chart shown in FIG. 5. It should be noted that this storage process is executed for the four colors C/M/Y/K, and only the area on the image memory 4 in which image data of each color is stored differs, and the processing contents are identical. Accordingly, a description will be given of the process relating to the image data of only one color.

First, before starting the storage process, variables are initialized (step S501). Here, the variables used in the storage process are “LCOUNT” (used in counting the number of processed lines), “ODDADDR” (odd-numbered line storage address pointer) and “EVENADDR” (even-numbered line storage address pointer). The variable “LCOUNT” is set to an initial value of 1, and the variables “ODDADDR” and “EVENADDR” are set to respective initial values indicating the start addresses of the areas set for respective data storage (the ODD start address and the EVEN start address shown in FIG. 3).

When the variable initialization is completed, a process for encoding the image data is started (step S502). As stated hereinbefore, the image data is arranged in a predetermined format consisting of data in single line units, and the single-line data portions are stored sequentially in the image memory 4 at predetermined locations thereof. After the image data is encoded, the variable “LCOUNT” is checked and an odd-numbered line/even-numbered line determination is made (step S503). If the variable “LCOUNT” indicates an odd number, the generated image data is stored at an odd-numbered line storage address indicated by the variable “ODDADDR” (step S504). After the data is stored, the variable “ODDADDR” is updated to a value that has been added by the size of the stored data (step S505).

By contrast, if the variable “LCOUNT” indicates an even number, then the generated image data is stored at an even-numbered line storage address indicated by the variable “EVENADDR” (step S506). After storage of the data, the variable “EVENADDR” is updated to a value that has been added by the size of the stored data (step S507) In either case, the variable “LCOUNT” is incremented after the image data is stored (step S508).

The processing from the step S502 to the step S508 is repeatedly executed until the variable “LCOUNT” value reaches a predetermined number of lines (step S509). Here, the predetermined number of lines corresponds to data for one page, and varies depending on the size of the printing paper. Moreover, although in the present embodiment an example is given in which the processing of image data for a single page is executed at a time, the present invention is not limited to this, and it is also possible to divide the image data for a single page into a plurality of blocks and process the blocks.

Following the completion of the process for storing image data in the image memory 4 as described above, the printing process is executed.

With the printing process of the present embodiment, the image data stored in the image memory 4 is transferred to the image data controllers 601 to 604 as described above, and output signals are generated in synchronism with the timing of scanning with output laser beams. The transfer of data from the image memory 4 to the image data controllers 601 to 604 is carried out using the DMA controller 5. In the present embodiment, two-beam/four-color image data scans are executed in parallel, and therefore the DMA controller 5 capable of executing eight-channel independent operations is used. For each of DMA channels the ODD start address or the EVEN start address is set as the “start address” and the “data size” of data to be transferred is set as well, and further the DMA controller 5 has a function that allows generation of an interrupt to indicate that the transfer of data is completed.

Next, a description will be given of data processing timing during execution of the printing process.

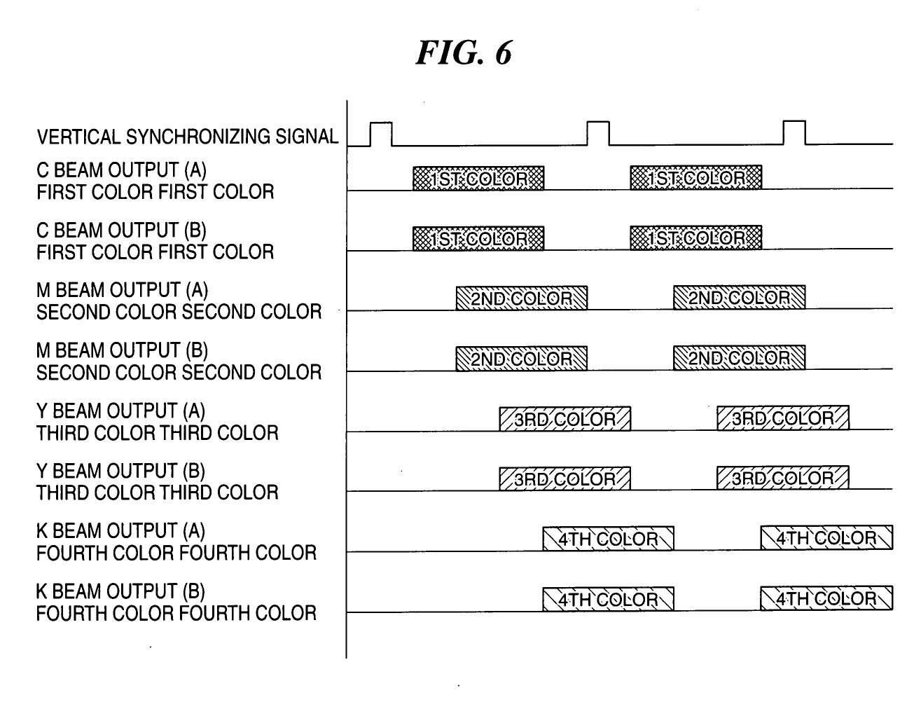

FIG. 6 is a timing diagram showing the relationship between vertical synchronizing signal and laser outputs during execution of the printing process.

With the printer engine 303 of the four-color parallel processing (tandem method)/two-beam scan type described above, as shown in FIG. 6, upon the lapse of a predetermined period of time after generation of a vertical synchronizing signal synchronized with the timing of start of printing of data for a page, output of two laser beams of C (first color) is started, and subsequently output of laser beams in the order of M (second color)→Y (third color)→(K (fourth color) is sequentially started at predetermined time intervals. As shown in FIG. 6, the beam outputs A and B of each color are generated almost simultaneously and correspond to the image data of the odd-numbered lines and the even-numbered lines described above, respectively.

Next, a description will be given of the above-described printing process with reference to the flow chart in FIG. 7.

Although the printing process is carried out for image data of the four colors C/M/Y/K, the procedure is the same for all the four colors except for the time difference shown in FIG. 6, and therefore a description will be given of the process for image data of one color only.

When the storage of the image data in the image memory 4 as described above is completed, a signal for instructing the start of printing is transmitted (step S701). This printing start instruction signal is a predetermined signal sent to and received from the engine 303 via the printer engine I/F 8, and has a preset format and is generated in predetermined timing. In the present embodiment, a means is provided for sending and receiving certain set commands using ordinary synchronous serial communication and is used.

Having received the print start instruction signal, the engine 303 outputs the vertical synchronizing signal shown in FIG. 6 in predetermined timing. A time period from the generation of the vertical synchronizing signal to the start of transmission of the image data is set for each color as shown in FIG. 6, starting the output of image data upon the lapse of the set time period causes images of the four colors to be superimposed one upon another to ultimately produce a single color image.

After awaiting after the generation of the vertical synchronizing signal and until the output start position is reached (step S702), the image data controller 601 starts output of image data (step S703). After the start of image data output, data is sequentially read from the FIFO memory 22 to execute data conversion as described before, and to supply replenish the read data, the DREQ generator 21 outputs a data request to the DMA controller 5. Therefore, the data to be transmitted is constantly supplied from the image memory 4 and the processing is continuously executed until the output of data for one page is completed (step S704). The data amount to be transmitted for a single page is set in the control register of the DMA controller 5 as stated before, and the DMA controller 5 generates an interrupt when it detects the completion of data transfer, to indicate the same. Upon the generation of an interrupt that indicates the completion of data transfer, the output of image data during execution of the printing process is terminated (step S705).

As described above, according to the present embodiment, storage areas are provided inside the image memory 4 for the respective laser beams, image data compressed line by line are stored in the respective storage areas, and the DMA controller 5 that is capable of operating independently and in parallel for the respective storage areas are used to transfer the respective image data to the image data controllers 601 to 604 corresponding to the respective laser beams. Therefore, the line buffer conventionally required is no longer needed, and as a result, it is possible to realize an image output apparatus which is inexpensive, flexible and free from increases in cost and size of the apparatus due to an increase in buffer memory capacity brought about by higher image quality and from complication of the line separation process brought about by a change in printing paper size or resolution.

To sum up, the present invention is characterized in that a configuration that is comprised of DMACs (Direct Memory Access Channels), and a data processor (image data controller) comprised of FIFO memories and expansion sections and performs image data processing control corresponding to output of laser beams is provided for image data for output processing using respective laser beams, to thereby realize a low-cost construction that transfers image data in a manner corresponding to output of the respective beams at high speed.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read from the storage medium realizes the functions of any of the embodiments described above, and hence the program code and the storage medium in which the program code is stored constitute the present invention.

Examples of the storage medium for supplying the program code include a floppy (registered trademark) disk, a hard disk, an optical disk, a magnetic-optical disk, a CD-ROM, a CD-R, a CD-RW, DVD-ROM, a DVD-RAM, a DVD-RW, a DVD+RW, a magnetic tape, a nonvolatile memory card, and a ROM. Alternatively, the program code may be downloaded directly from a computer, database, or the like, not shown, that is connected via the Internet, a commercial network, a local area network, or the like.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

The form of the program may be an object code, a program code executed by an interpreter, or script data supplied to an OS (Operating System).

### CROSS REFERENCE TO RELATED APPLICATION

This application claims priority from Japanese Patent Application No. 2003-435642 filed Dec. 26, 2003, which is hereby incorporated by reference herein.

1. An image output apparatus that supplies a plurality of image signals for controlling a plurality of light beams, respectively, to a printer apparatus that forms an image by scanning the plurality of light beams simultaneously and in parallel, comprising:
a plurality of storage devices that store a plurality of image data corresponding, respectively, to the plurality of light beams; and
a plurality of data processing devices that convert respective ones of the plurality of image data output from said plurality of storage devices into the plurality of image signals for controlling the plurality of light beams, respectively and output the image signals to the printer apparatus; and
a transfer device that transfers the plurality of image data stored in said plurality of storage devices to said data processing devices according to processing results of said data processing devices.

2. An image output apparatus according to claim 1, comprising a separation device that separates image data formatted in units for scanning into a plurality of image data corresponding, respectively, to the plurality of light beams, and
wherein each of said plurality of storage devices stores corresponding data of the plurality of image data separated by said separation device in scanning order.

3. An image output apparatus according to claim 2, further comprising a data compression device that compresses image data, and
wherein said data compression device compresses the plurality of image data stored in said storage devices before being formatted in units for scanning, and
wherein each of said data processing devices expands corresponding data of the compressed image data and said transfer device supplies the expanded image data to a corresponding one of said data processing devices as the expansion is carried out.

4. An image output apparatus according to claim 1, wherein the image signals output from said data processing devices are output in synchronism with a signal supplied from the printer apparatus.

5. An image output apparatus according to claim 1, wherein said transfer device comprises a DMA controller comprising independently operable DMA channels corresponding in number to the number of the light beams.

6. An image output method for an image output apparatus that supplies a plurality of image signals for controlling a plurality of light beams, respectively, to a printer apparatus that forms an image by scanning the plurality of light beams simultaneously and in parallel, comprising:
a storage step of storing a plurality of image data corresponding, respectively, to the plurality of light beams in a plurality of discrete storage areas, respectively;
a transfer step of transferring the plurality of image data stored in said plurality of discrete storage areas separately and independently to a plurality of data processing devices; and
a data processing step of converting the plurality of image data transferred in said transfer step into the plurality of image signals for controlling the plurality of light beams, respectively and outputting the image signals to the printer apparatus.

7. An image output method according to claim 6, wherein said storage step comprises separating image data formatted in units for scanning into a plurality of image data corresponding, respectively, to the plurality of light beams and storing the separated plurality of image data in the storage areas in scanning order.

8. An image output method according to claim 7, further comprising a data compression step of compressing the plurality of image data stored in the storage areas before being formatted in units for scanning, and
wherein said data processing step comprises expanding the compressed image data and said transfer step comprises supplying the expanded image data to the data processing devices as the expansion is carried out.

9. An image output method according to claim 6, wherein the image signals output in said data processing step are output in synchronism with a signal supplied from the printer apparatus.

10. A computer-readable program for executing an image output method for an image output apparatus that supplies a plurality of image signals for controlling a plurality of light beams, respectively, to a printer apparatus that forms an image by scanning the plurality of light beams simultaneously and in parallel, comprising:
a storage module for storing a plurality of image data corresponding, respectively, to the plurality of light beams in a plurality of discrete storage areas, respectively;
a transfer module for transferring the plurality of image data stored in said plurality of discrete storage areas separately and independently to a plurality of data processing devices; and
a data processing module for converting the plurality of image data transferred by said transfer module into the plurality of image signals for controlling the plurality of light beams, respectively and outputting the image signals to the printer apparatus.

11. A control program according to claim 10, wherein said storage module separates image data formatted in units for scanning into a plurality of image data corresponding, respectively, to the plurality of light beams and stores the separated plurality of image data in the storage areas in scanning order.

12. A control program according to claim 11, wherein the plurality of image data stored in the storage areas are compressed before being formatted in units for scanning, and
wherein said data processing module expands the compressed image data and said transfer module supplies the expanded image data to the data processing devices as the expansion is carried out.

13. A control program according to claim 10, wherein the image signals output by said data processing module are output in synchronism with a signal supplied from the printer apparatus.
